(19) United States
(12) Patent Application Publication
(10) Pub. No.: US 2022/0104652 A1
(43) Pub. Date: Apr. 7, 2022

(54) Beverage Brewing System and Method

(71) Applicant: Trent Walker, West Orange, NJ (US)

(72) Inventor: Trent Walker, West Orange, NJ (US)

(21) Appl. No.: 17/450,129

(22) Filed: Oct. 6, 2021

Related U.S. Application Data
(60) Provisional application No. 63/088,498, filed on Oct. 7, 2020.

(51) Int. Cl. A47J 31/44; G06F 16/38; G05B 19/042

(52) U.S. Cl. CPC A47J 31/4492; G05B 19/0426; G06F 16/381

(57) ABSTRACT

A beverage brewing device including a scanner to scan codes attached to a container of a beverage solid, and then provides brewing parameters such as temperature and time to a brewing system. The code used may be a UPC code or a custom code. A user of the brewing device can scan the identifiable code, and either obtain brewing parameters from the code or use the code to access brewing parameters from a database. The brewing parameters are then used by the brewing device to brew the beverage. The brewing parameters may be stored locally for the next use. The method scans the code, obtains the brewing parameters and instructs the brewing of a beverage.

### PRIORITY

This application claims domestic benefit from pending provisional application No. 63/088,498, filed Oct. 7, 2020, and is incorporated by reference.

### FIELD OF INVENTION

This invention is in the field of beverage brewing systems and methods, and more particularly, for brewing beverages such as coffee, tea, or hot chocolate, where the desired beverages may have preferred or recommended brewing temperature, brewing time, or any other set of parameters for optimal brewing.

### BACKGROUND

There are many devices for brewing coffee, tea, and other beverages based on solids that are then brewed in water. Some, such as smart electric kettles, allow you to select a temperature for the water and then pour that water into a teapot to brew the tea. Other machines are “single button” push and will brew coffee or tea at a consistent temperature regardless of the product being brewed.

These existing machines require the operator of the machine to know the ideal temperature and time at which he or she should brew the beverage, or just provide a ‘one size fits all’ approach to brewing. However, it is the case that teas and coffees are especially complex, especially tea. Different leaves, different flowers, and different characteristics may require recommended temperatures in ranges from 50 degrees Celsius to 100 degrees Celsius, and brew or steep times in ranges from 2 minutes to 7 minutes. The manufacturer or preparer of the coffee, tea, or other beverage solid is most likely know the proper temperatures and/or brewing times, but would then not be the operator of the machine used for brewing, thereby leaving a knowledge gap preventing optimal beverage brewing.

This invention addresses this problem by providing a way for the optimal brewing parameters to be efficiently conveyed from manufacturer or preparer of the beverage solid to the machine or the operator of the machine, and allows the brewing parameters to be entered automatically in the brewing machine.

In particular, the invention will be able to scan codes provided by the manufacturer or supplier of the coffee, tea, or other beverage solid and then use either a database lookup or a direct instruction set to retrieve the appropriate brewing times, temperature, and other brewing parameters.

### SUMMARY

The invention combines optical or RFID scanning with a brewing machine that can alter brewing parameters such as time and temperature along with the ability of the brewing machine to fetch remote brewing parameters. The operator will take the substance to be brewed, and scan a code relating to this substance, such as a code attached to a container. The brewing machine will read this code and (a) use information in this code to adjust the brewing parameters in the machine, (b) search for the code in a local database of brewing parameters, or (c) use this information in the code to acquire brewing parameters from a remote database. The brewing parameters may be implemented directly or stored in the local database for future use.

### BRIEF DESCRIPTION OF THE DRAWINGS

FIG. 1 is a perspective view of a preferred embodiment, showing the feature of the brewing system.

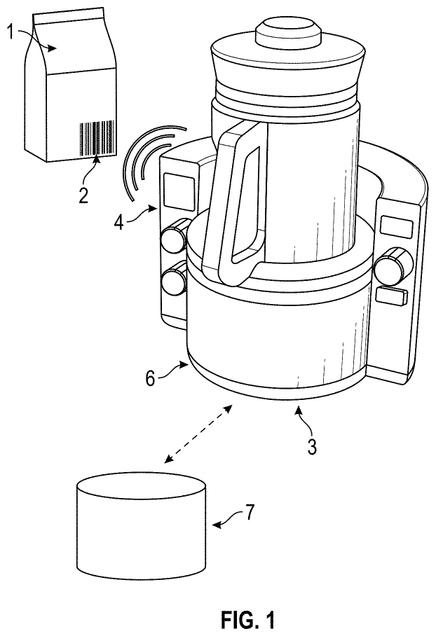

FIG. 2 is a flow chart showing the steps of a preferred embodiment of the new method.

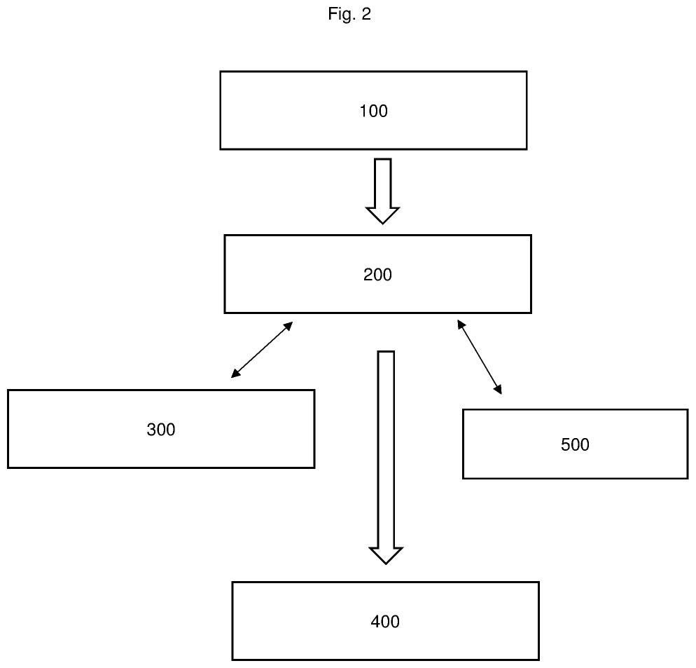

### DETAILED DESCRIPTION

The invention preferably consists of a scanner 4 for reading a code 2 on packaging 1 for a solid to be brewed. The code 2 is then compared by processor 6 with a local database of codes and brewing instructions 7, and if a match is found, the brewing instructions are passed on to the brewing system 3.

Common solids used for brewing beverage include coffee grounds and tea leaves and may also include cocoa or other ingredients used to make brewed beverages. The code 2 associated with the beverage solid may be a UPC code, or may be a special code for use with the brewing system. The code may be presented a QR code, bar code, or an infrared or hologram image. The code 2 may itself contain brewing instructions or may be used as a key to retrieve relevant brewing instructions from a database of brewing instructions.

The scanner 4 may be any device capable of reading the code, including such known devices as optical cameras or infrared scanners. In one embodiment, the scanner could be a mobile device such as a phone or tablet, where the mobile device is capable of communicating with the brewing system, for example, by Bluetooth or Wi-Fi.

The local database 7 contains a table of codes for solids to be brewed and associated brewing instructions. The brewing instructions preferably include brewing time and brewing temperature, and may also include more complicated instructions, such as brewing stages, where the brewing time and/or temperature may vary during the brewing process.

If the processor 6 cannot find a brewing instruction set in the local database 7 that corresponds with the input code, the processor then may access a remote database with a broader collection of brewing instructions. The remote database may be stored on a separate storage device near the brewing machine 3, or may be accessed over the Internet, such as a dedicated remote database or a manufacturer's website.

Preferably, once a brewing instruction set is retrieved from the remote database, the retrieved instruction set is stored in the local database for quicker access.

A brewing instruction set, with or without an associated code may be entered into either the local database or remote database. This entry may be made by an operator, by a manufacturer of the brewing system, or a manufacturer or provider of the beverage solid.

The inventive method includes the steps of reading an input code 100, comparing the input code to a database of codes and brewing instructions 200, retrieving a brewing instruction set associated with the input code 300, and passing the brewing instruction set to the brewing system 400.

In a variation of the method, additional step 500 of accessing a remote database of brewing instructions to retrieve a remote brewing instruction set may be added where step 300 fails to retrieve a brewing instruction set. The remote brewing instruction set would then be passed on to the brewing system 400, and preferably stored in the local database.

One use of the invention allows a manufacturer or distributor of coffee, tea, or another beverage solid to easily transmit the preferred brewing conditions directly to a consumer's brewing machine.

As an example, a manufacturer of coffee beans may believe that optimal brewing of his or her coffee is at 85 degrees Celsius for 250 seconds. The manufacturer will often have a UPC code tagged onto the coffee and can use this code to link the coffee with these brewing parameters in a remote system. The manufacturer may arrange a database through an application or website where the product UPC code is associated with the preferred brewing temperature and brewing time. When a consumer buys the coffee beans, the consumer will scan the UPC code on the coffee machine and the coffee machine will retrieve the brewing temperature and brewing time from the remote system and then configure itself. The brewing system may also display these brewing parameters, and even allow for the consumer to modify the parameters before brewing. The brewing machine then would brew the coffee according to the desired parameters.

The brewing system may also periodically access the remote database to retrieve new brewing instructions and associated codes for local storage.

While certain novel features of the present invention have been shown and described, it will be understood that various omissions, substitutions and changes in the forms and details of the device illustrated and in its operation can be made by those skilled in the art without departing from the spirit of the invention.

I claim:

1. A beverage brewing system comprising:
a scanner for reading an input beverage code;
a first database of beverage codes and brewing instructions; and
a processor for comparing the input beverage code with the first database of beverage codes and brewing instructions, and retrieving a first set of brewing instructions corresponding with the input brewing code;
a control system to direct the brewing of a beverage based on the retrieved set of brewing instructions.

2. The beverage brewing system of claim 1, further comprising:
a beverage brewing apparatus capable of receiving the retrieved set of brewing instructions and adjusting its operation to following the retrieved set of brewing instructions.

3. The beverage brewing system of claim 1, further comprising:
a data entry subsystem for entering a new beverage code and new brewing instructions into the first database of beverage codes and brewing instructions.

4. The beverage brewing system of claim 1, further comprising:
a display to display the retrieved brewing instructions.

5. The beverage brewing system of claim 1, further comprising:
input means allowing a user to modify the retrieved brewing instructions before the control system directs brewing.

6. The beverage brewing system of claim 1, where the processor may interpret the input beverage code as brewing instructions.

7. The beverage brewing system of claim 1, further comprising:
a second database of beverage codes and brewing instructions; and
a query system to compare the input beverage code with the second database of beverage codes and brewing instructions, and retrieve a second set of brewing instructions corresponding with the input beverage code.

8. The beverage brewing system of claim 7,
where the second database of beverage codes and brewing instructions is located remotely from the processor; and
the beverage brewing system further comprises communications means to access the second database of beverage codes and brewing instructions and retrieve a set of brewing instructions.

9. The beverage brewing system of claim 1, where the scanner is a mobile device.

10. A method for determining desired beverage brewing parameters of a beverage solid, the method comprising:
scanning an input beverage code associated with the beverage solid;
comparing the input beverage code with a first database of beverage codes and brewing instructions, to retrieve a brewing instruction set that matches the input beverage code; and
passing the retrieved brewing instruction set on to a control system as parameters for brewing a beverage from the beverage solid.

11. The method of claim 10, further comprising:
entering a beverage code and brewing instructions into the first database of beverage codes and brewing instructions.

12. The method of claim 10, further comprising:
accessing a second database of beverage codes and brewing instructions, to retrieve a brewing instruction set that matches the input beverage code.

13. The method of claim 10, further comprising:
storing the retrieved brewing instruction set and input beverage code into the first database of beverage codes and brewing instructions.

14. The method of claim 10, further comprising:
recognizing the input beverage code as brewing instructions;
passing the input beverage code to the control system as parameters for brewing a beverage from the beverage solid.
